(19) United States
(12) Patent Application Publication
(10) Pub. No.: US 2021/0109491 A1
(43) Pub. Date: Apr. 15, 2021

(54) POLICY IMPROVEMENT METHOD, NON-TRANSITORY COMPUTER-READABLE STORAGE MEDIUM FOR STORING POLICY IMPROVEMENT PROGRAM, AND POLICY IMPROVEMENT DEVICE

(71) Applicant: FUJITSU LIMITED, Kawasaki-shi (JP)

(72) Inventors: Junichi Shigezumi, Kawasaki (JP); Tomotake Sasaki, Kawasaki (JP); Hidenao Iwane, Kawasaki (JP); Hitoshi Yanami, Kawasaki (JP)

(73) Assignee: FUJITSU LIMITED, Kawasaki-shi (JP)

(21) Appl. No.: 17/035,793

(22) Filed: Sep. 29, 2020

(30) Foreign Application Priority Data
Oct. 15, 2019 (JP) 2019-188989

(51) Int. Cl. G05B 19/042; G06N 20/00; F24F 11/63

(52) U.S. Cl. CPC G05B 19/042; G06N 20/00; G05B 2219/2614; G05B 2219/40499; F24F 11/63

(57) ABSTRACT

A policy improvement method for reinforcement learning using a state value function, the method including: calculating, when an immediate cost or immediate reward of a control target in the reinforcement learning is defined by a state and an input, an estimated parameter that estimates a parameter of the state value function for the state of the control target; contracting a state space of the control target using the calculated estimated parameter; generating a TD error for the estimated state value function that estimates the state value function in the contracted state space of the control target by perturbing each parameter that defines the policy; generating an estimated gradient that estimates the gradient of the state value function with respect to the parameter that defines the policy, based on the generated TD error and the perturbation; and updating the parameter that defines the policy using the generated estimated gradient.

### CROSS-REFERENCE TO RELATED APPLICATION

This application is based upon and claims the benefit of priority of the prior Japanese Patent Application No. 2019-188989, filed on Oct. 15, 2019, the entire contents of which are incorporated herein by reference.

### FIELD

The embodiments discussed herein are related to a policy improvement method, a non-transitory computer-readable storage medium storing a policy improvement program, and a policy improvement device.

### BACKGROUND

There is traditionally a technique of reinforcement learning which improves a value function to evaluate a policy using a cumulative cost or cumulative reward based on an immediate cost or immediate reward that occurs according to an input to the control target, and improves a policy so that the cumulative cost or cumulative reward is optimized. The value function is, for example, a state-behavior value function (Q function), a state value function (V function), or the like. The policy improvement corresponds, for example, to updating a policy parameter.

As a prior art, for example, there is a technique for updating a policy parameter. For example, a computer generates a temporal difference error (TD error) with respect to an estimated state value function, which estimates a state value function, by perturbing each of the elements of the feedback coefficient matrix that provides the policy. The computer generates an estimated gradient function matrix which estimates the gradient function matrix of the state value function with respect to the feedback coefficient matrix for the state based on the TD error and the perturbation, and uses the estimated gradient function matrix to update the feedback coefficient matrix. For example, there is a technique for imparting a control signal to a control target, observing the state quantity of the control target, obtaining a TD error from the observation result, updating a TD error approximator, and updating the policy.

Examples of the related art include Japanese Laid-open Patent Publication Nos. 2019-053593 and 2007-065929.

### SUMMARY

According to an aspect of the embodiments, provided is a policy improvement method for reinforcement learning using a state value function, the method including: calculating, when an immediate cost or immediate reward of a control target in the reinforcement learning is defined by a state and an input, an estimated parameter that estimates a parameter of the state value function for the state of the control target; contracting a state space of the control target using the calculated estimated parameter; generating a TD error for the estimated state value function that estimates the state value function in the contracted state space of the control target by perturbing each parameter that defines the policy; generating an estimated gradient that estimates the gradient of the state value function with respect to the parameter that defines the policy, based on the generated TD error and the perturbation; and updating the parameter that defines the policy using the generated estimated gradient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a policy improvement method according to an embodiment;

FIG. 2 is a block diagram illustrating a hardware configuration example of a policy improvement device 100;

FIG. 3 is an explanatory diagram illustrating an example of contents stored in a history table 300;

FIG. 4 is a block diagram illustrating a functional configuration example of the policy improvement device 100;

FIG. 5 is an explanatory diagram illustrating an example of reinforcement learning;

FIG. 6 is an explanatory diagram (#1) illustrating a specific example of a control target 110;

FIG. 7 is an explanatory diagram (#2) illustrating a specific example of the control target 110;

FIG. 8 is an explanatory diagram (#3) illustrating a specific example of the control target 110;

FIG. 9 is a flowchart illustrating an example of a batch processing format reinforcement learning processing procedure;

FIG. 10 is a flowchart illustrating an example of a sequential processing format reinforcement learning processing procedure;

FIG. 11 is a flowchart illustrating an example of policy improvement processing procedures;

FIG. 12 is a flowchart illustrating an example of estimation processing procedures; and

FIG. 13 is a flowchart illustrating an example of update processing procedures.

### DESCRIPTION OF EMBODIMENT(S)

However, in the existing technique, the processing time taken for reinforcement learning may be increased. For example, the larger the number of dimensions of the state of the control target, the larger the number of parameters of the policy, which leads to an increase in the processing time taken to obtain the policy determined to be appropriate by the reinforcement learning.

According to one aspect, provided is a solution to reduce the processing time taken for reinforcement learning.

Hereinafter, embodiments of a policy improvement method, a policy improvement program, and a policy improvement device according to the present invention are described in detail with reference to the drawings.

(Example of Policy Improvement Method according to Embodiment)

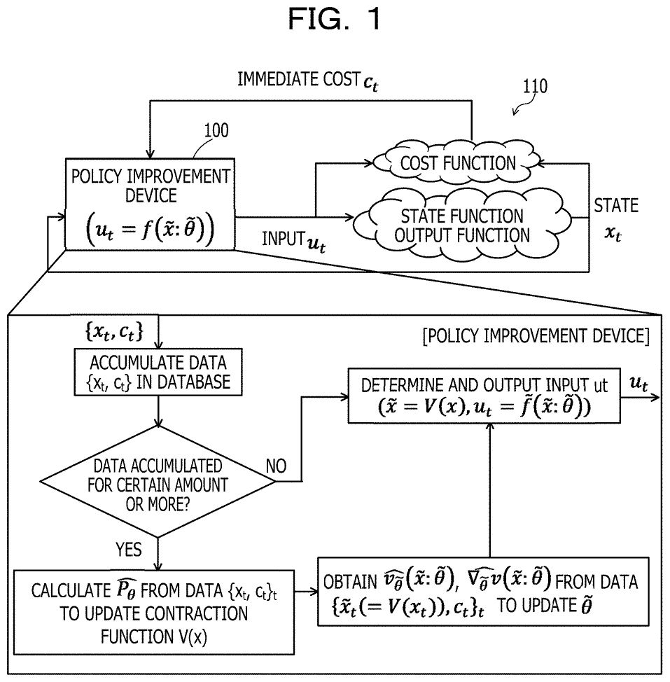

FIG. 1 is an explanatory diagram illustrating an example of a policy improvement method according to an embodiment. A policy improvement device 100 is a computer that controls a control target 110 by improving a policy and determining an input to the control target 110 by the policy. The policy improvement device 100 is, for example, a server, a personal computer (PC), a microcontroller, or the like.

The control target 110 is some event, such as a physical system that actually exists. The control target 110 is also referred to as an environment. The control target 110 is, for example, a server room, an air conditioning apparatus, a power generation apparatus, an industrial machine, or the like. The policy is an equation which determines an input value for the control target 110 according to a predetermined parameter. The policy is also called a control law. The predetermined parameter is, for example, a feedback coefficient matrix.

The policy improvement corresponds to updating a policy parameter. The policy improvement is the modification of a policy so that the cumulative cost and cumulative reward may be optimized more efficiently. The input is an operation on the control target 110. The input is also called an action. The state of the control target 110 changes according to the input to the control target 110, and an immediate cost or an immediate reward occurs. The state and immediate cost or immediate reward of the control target 110 are observable.

Although there have heretofore been considered various methods for improving the policy, it is difficult to efficiently perform reinforcement learning and it is difficult to suppress an increase in processing time taken for the reinforcement learning by any of the methods.

For example, referring to the above Japanese Laid-open Patent Publication No. 2019-053593, a method of improving a policy by perturbing each parameter of the policy, obtaining a TD error, and updating the parameter of the policy based on the TD error and the perturbation is conceivable. Even with this method, it is difficult to efficiently perform reinforcement learning, and it is difficult to suppress an increase in processing time taken for reinforcement learning. For example, the larger the number of dimensions of the state of the control target 110, the larger the number of parameters of the policy, making it is impossible to suppress the increase in the processing time taken to obtain the policy determined to be appropriate by the reinforcement learning.

On the other hand, referring to Reference Document 1 below, a method of updating the parameters of the policy after reducing the number of parameters of the policy is conceivable by using a full-rank matrix, projecting a state space, and converting a linear-quadratic regulator (LQR) problem representing the control target 110 into a projective LQR problem.
Reference Document 1: Guldogan, Yaprak, et al. “Low rank approximate solutions to large-scale differential matrix Riccati equations.” arXiv preprint arXiv:1612.00499 (2016).

However, this method may not be applied when a specific equation that defines the LQR problem is unknown, and it is difficult to efficiently perform reinforcement learning, making it impossible to suppress an increase in processing time taken for reinforcement learning is suppressed. For example, this method may not be applied when the coefficient matrix that defines the linear state equation and the coefficient matrix that defines the cost function in the LQR problem are unknown.

Therefore, in this embodiment, description is given of a policy improvement method capable of reducing the processing time taken for reinforcement learning, without being applied only to when the problem is known or when the problem is linear, by contracting the state space and reducing the number of parameters of the policy to efficiently perform the reinforcement learning.

In the example of FIG. 1, the state of the control target 110 is x, the input to the control target 110 is u, and the immediate cost of the control target 110 is c. At time t, the state of the control target 110 is xₜ, the input to the control target 110 is uₜ, and the immediate cost of the control target 110 is cₜ. The state xₜ of the control target 110 is directly observable.

It is assumed that how the state of the control target 110 changes is unknown. The state change of the control target 110 is defined by a state function (output function). The state function is a function whose shape is known but whose parameters such as coefficients are unknown.

It is assumed that how the immediate cost cₜ occurs is unknown. How the immediate cost cₜ occurs is defined by a cost function using the state xₜ and the input uₜ. The cost function is a function whose shape is known, but whose parameters such as coefficients are unknown.

The policy improvement device 100 stores a contraction function V(x) that contracts an n-dimensional state x to an n′-dimensional state x\tilde{ }. Here, n>n′. For convenience, a symbol with attached above x described in the drawings, formulas, and the like, for example, is expressed as “x\tilde{ }” in the description. In the following description, a multidimensional space in which the state x exists may be referred to as “the space X of the state x”. A multidimensional space in which the state x\tilde{ } is present may be referred to as “the space X\tilde{ } of the state x\tilde{ }”.

The policy improvement device 100 stores a state value function v(x:θ) for the state x of the control target 110. The policy improvement device 100 also stores the policy. The policy is defined by the state feedback function f(x\tilde{ }:θ\tilde{ }) represented by the following formula (1). For convenience, a symbol with \tilde{ } attached above θ described in the drawings, formulas, and the like, for example, is expressed as “θ\tilde{ }” in the description. θ\tilde{ } is a parameter of the state feedback function f(x\tilde{ }:θ\tilde{ }). θ\tilde{ } is, for example, an array of a plurality of parameter elements.

uₜ=ƒ(\tilde{x}:\tilde{θ}) (1)

In FIG. 1, (1-1) the policy improvement device 100 calculates an estimated parameter P\hat{ }_{θ} by estimating the parameter P_{θ} of the state value function v(x:θ) for the state x of the control target 110. For convenience, for example, a symbol with \hat{ } attached above P_{θ} described in the drawings, formulas, and the like, for example, is expressed as “P\hat{ }_{θ}” in the description. The policy improvement device 100 contracts the space X of the state x of the control target 110 using the calculated estimated parameter P\hat{ }_{θ}.

The policy improvement device 100 stores data {xₜ, cₜ} in the database every time the data is acquired, for example. The policy improvement device 100 repeatedly determines the input uₜ to be outputted to the control target 110, based on the current policy uₜ=f(x\tilde{ }:\tilde{θ}) and the current contraction function V(x) until a certain amount or more of data {xₜ, cₜ} is accumulated. Thus, the policy improvement device 100 acquires new data {xₜ, cₜ}.

Then, when a certain amount or more of data {xₜ, cₜ} is accumulated, the policy improvement device 100 calculates the estimated parameter P\hat{ }_{θ} from the accumulated data {xₜ, cₜ}ₜ. The data {•}ₜ represents a collection of data {•} at a plurality of times. The policy improvement device 100 updates the contraction function V(x) using the calculated estimated parameter P\hat{ }_{θ}, and contracts the space X of the state x of the control target 110 to the space X\tilde{ } of the states x\tilde{ } of the control target 110.

(1-2) The policy improvement device 100 generates an estimated gradient ∇\hat{ }_{θ\tilde{ }}v(x\tilde{ }:θ\tilde{ }) by estimating a gradient ∇_{θ\tilde{ }}v(x\tilde{ }:θ\tilde{ }) of a state value function v(x:θ) with respect to a parameter θ\tilde{ } that defines the policy with respect to the contracted space X\tilde{ } of the state x\tilde{ } of the control target 110. For convenience, a symbol with a subscript θ\tilde{ } attached to ∇ described in the drawings, formulas, and the like, for example, is expressed as “∇_{θ\tilde{ }}” in the description. For convenience, a symbol with \hat{ } attached above ∇_{θ\tilde{ }}v described in the drawings, formulas, and the like, for example, is expressed as “∇_{θ\tilde{ }}v” in the description. The policy improvement device 100 updates the parameter θ\tilde{ } that defines the policy by the following formula (2) using the generated estimated gradient ∇\hat{ }_{θ\tilde{ }}v(x\tilde{ }:θ\tilde{ }).

\tilde{θ}←\tilde{θ}−α(Σₖ₌₁^{M} [symbol] (\tilde{x}^{[k]}:\tilde{θ})) (2)

For example, the policy improvement device 100 obtains the estimated state value function ∇\hat{ }_{θ\tilde{ }}(x\tilde{ }:θ\tilde{ }) from the data {(x″ₜ=V(xₜ)), cₜ}ₜ in the contracted space X\tilde{ } of the state x\tilde{ } of the control target 110, and obtains the estimated gradient ∇\hat{ }_{θ\tilde{ }}v(x\tilde{ }:θ\tilde{ }). For convenience, a symbol with a subscript θ\tilde{ } attached to v described in the drawings, formulas, and the like, for example, is expressed as “v_{θ\tilde{ }}” in the description. For convenience, a symbol with \hat{ } attached above v_{θ\tilde{ }} described in the drawings, formulas, and the like, for example, is expressed as “v\hat{ }_{θ\tilde{ }}” in the description. The policy improvement device 100 updates the parameter θ\tilde{ } that defines the policy by the above formula (2) using the obtained estimated gradient ∇\hat{ }_{θ\tilde{ }}(x\tilde{ }:θ\tilde{ }).

For example, the policy improvement device 100 generates a TD error by perturbing a parameter θ\tilde{ } that defines the policy and obtaining the estimated state value function v\hat{ }(x\tilde{ }:θ\tilde{ }) from the data {(x\tilde{ }ₜ=V(xₜ)), cₜ}ₜ for the contracted space X\tilde{ } of the state x\tilde{ } of the control target 110. Next, the policy improvement device 100 generates an estimated gradient ∇\hat{ }_{θ\tilde{ }}v(x\tilde{ }:θ\tilde{ }) based on the generated TD error and the perturbation. The policy improvement device 100 updates the parameter θ\tilde{ } that defines the policy by the above formula (2) using the generated estimated gradient ∇\hat{ }_{θ\tilde{ }}v(x\tilde{ }:θ\tilde{ }).

(1-3) The policy improvement device 100 calculates the input uₜ based on the updated policy uₜ=f(x\tilde{ }:θ\tilde{ }) and the updated contraction function V(x), and outputs the input to the control target 110. Thus, the policy improvement device 100 may control the control target 110 according to the updated policy uₜ=f(x\tilde{ }:θ\tilde{ }).

As a result, the policy improvement device 100 may reduce the number of elements of the parameter θ\tilde{ } that defines the policy even when the problem representing the control target 110 is not linear or the problem representing the control target 110 is unknown. Therefore, the policy improvement device 100 is capable of improving the learning efficiency in the reinforcement learning and reducing the processing time taken for the reinforcement learning.

A description has been provided for the case where the policy improvement device 100 determines the input uₜ according to the policy uₜ=f(x\tilde{ }:θ\tilde{ }) and outputs it to the control target 110, but the embodiment is not limited thereto. For example, the policy improvement device 100 may cooperate with another computer that determines the input uₜ according to the policy uₜ=f(x\tilde{ }:θ\tilde{ }) and outputs the input to the control target 110.

A description has been provided for the case where the policy improvement device 100 acquires the immediate cost of the control target 110 for use in reinforcement learning, but the embodiment is not limited thereto. For example, the policy improvement device 100 may acquire an immediate reward for the control target 110 for use in reinforcement learning.

(Hardware Configuration Example of Policy Improvement Device 100)

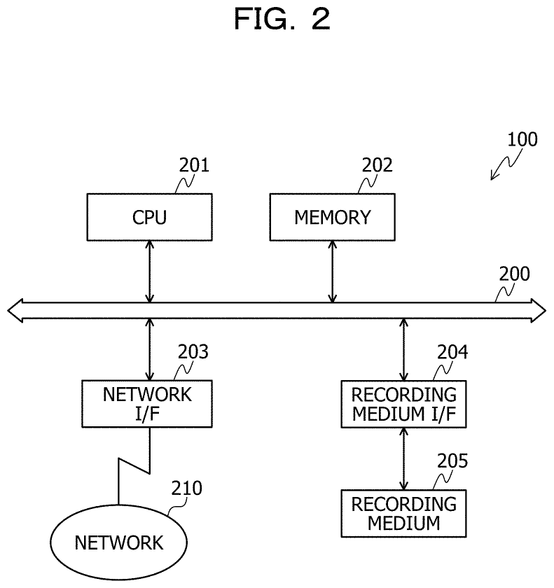

Next, a hardware configuration example of the policy improvement device 100 illustrated in FIG. 1 is described with reference to FIG. 2.

FIG. 2 is a block diagram illustrating a hardware configuration example of the policy improvement device 100. In FIG. 2, the policy improvement device 100 includes a central processing unit (CPU) 201, a memory 202, a network interface (I/F) 203, a recording medium I/F 204, and a recording medium 205. Each of the configuration portions is coupled to each other via a bus 200.

The CPU 201 controls the entire policy improvement device 100. The memory 202 includes, for example, a read-only memory (ROM), a random-access memory (RAM), a flash ROM, and the like. For example, the flash ROM or the ROM stores various programs, and the RAM is used as a work area of the CPU 201. The program stored in the memory 202 causes the CPU 201 to execute coded processing by being loaded into the CPU 201.

The network I/F 203 is coupled to the network 210 through a communication line and is coupled to another computer via the network 210. The network I/F 203 controls the network 210 and an internal interface so as to control data input/output from/to the other computer. The network I/F 203 is, for example, a modem, a local area network (LAN) adapter, or the like.

The recording medium I/F 204 controls reading/writing of data from/to the recording medium 205 under the control of the CPU 201. The recording medium I/F 204 is, for example, a disk drive, a solid-state drive (SSD), a Universal Serial Bus (USB) port, or the like. The recording medium 205 is a nonvolatile memory that stores the data written under the control of the recording medium I/F 204. The recording medium 205 is, for example, a disk, a semiconductor memory, a USB memory, or the like. The recording medium 205 may be removable from the policy improvement device 100.

In addition to the above-described components, the policy improvement device 100 may include, for example, a keyboard, a mouse, a display, a touch panel, a printer, a scanner, a microphone, a speaker, and the like. The policy improvement device 100 may include multiple recording medium I/Fs 204 and recording media 205. The policy improvement device 100 does not have to include the recording medium I/F 204 or the recording medium 205.

(Stored Contents of History Table 300)

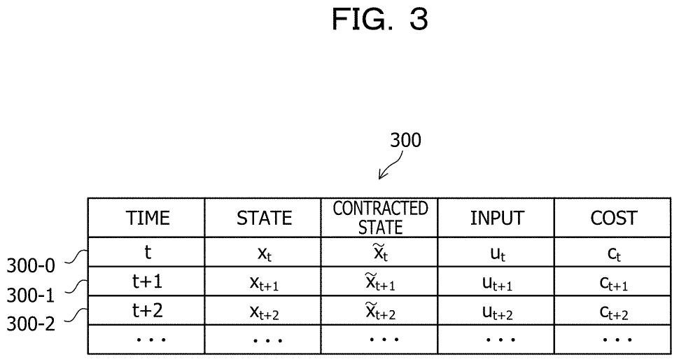

Next, an example of contents stored in a history table 300 is described with reference to FIG. 3. The history table 300 is realized by, for example, a storage region such as the memory 202 or the recording medium 205 of the policy improvement device 100 illustrated in FIG. 2.

FIG. 3 is an explanatory diagram illustrating an example of contents stored in the history table 300. As illustrated in FIG. 3, the history table 300 includes fields for time, state, contracted state, input, and cost. The history table 300 stores history information as a record 300-a by setting information in each field for each time point. Here, suffix a is an arbitrary integer.

In the time field, the time of applying the input to the control target 110 is set. In the time field, a time represented by a multiple of the unit time is set, for example. In the state field, the state of the control target 110 at the time set in the time field is set. In the contracted state field, a state obtained by contracting the state set in the state field by a contraction function is set. In the input field, the input applied to the control target 110 at the time set in the time field is set. In the cost field, the immediate cost observed at the time set in the time field is set.

The history table 300 may include a reward field in place of the cost field in the case where the immediate rewards are used instead of the immediate costs in the reinforcement learning. In the reward field, the immediate reward observed at the time set in the time field is set.

(Functional Configuration Example of Policy Improvement Device 100)

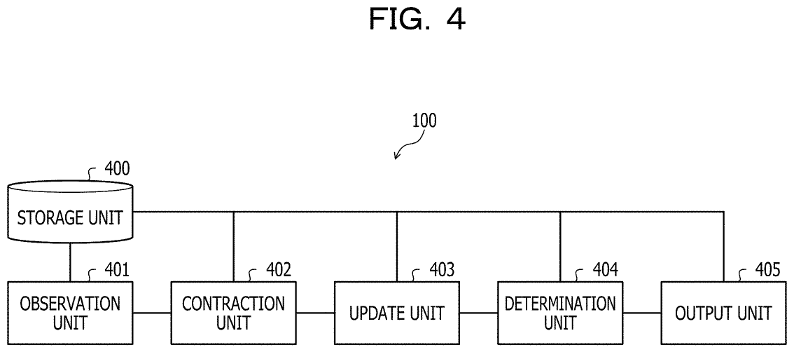

Next, a functional configuration example of the policy improvement device 100 is described with reference to FIG. 4.

FIG. 4 is a block diagram illustrating a functional configuration example of the policy improvement device 100. The policy improvement device 100 includes a storage unit 400, an observation unit 401, a contraction unit 402, an update unit 403, a determination unit 404, and an output unit 405.

The storage unit 400 is realized by using, for example, a storage region, such as the memory 202 or the recording medium 205 illustrated in FIG. 2. Hereinafter, the case where the storage unit 400 is included in the policy improvement device 100 is described, but the embodiment is not limited thereto. For example, there may be a case where the storage unit 400 is included in a device different from the policy improvement device 100, and the stored contents of the storage unit 400 are able to be referred to through the policy improvement device 100.

The units from the observation unit 401 to the output unit 405 function as an example of a control unit. For example, the functions of the units from the observation unit 401 to the output unit 405 are implemented by, for example, causing the CPU 201 to execute a program stored in the storage region such as the memory 202 or the recording medium 205 illustrated in FIG. 2, or by using the network I/F 203. Results of processing performed by each functional unit are stored, for example, in the storage region, such as the memory 202 or the recording medium 205 illustrated in FIG. 2.

The storage unit 400 stores various types of information to be referred to or updated in the processing of each functional unit. The storage unit 400 stores the input, the state, and the immediate cost or immediate reward of the control target 110. The immediate cost or immediate reward is defined, for example, by the state and the input. The immediate cost or immediate reward is defined, for example, in a quadratic form of the state and the input. The state change of the control target 110 is defined, for example, by a linear difference equation. The storage unit 400 may also store the contracted state. The storage unit 400 stores, for example, the input, the state, the contracted state, and the immediate cost or immediate reward of the control target 110 at each time using the history table 300 illustrated in FIG. 3. As a result, the storage unit 400 makes it possible for each functional unit to refer to the input, the state, the contracted state, and the immediate cost or immediate reward of the control target 110.

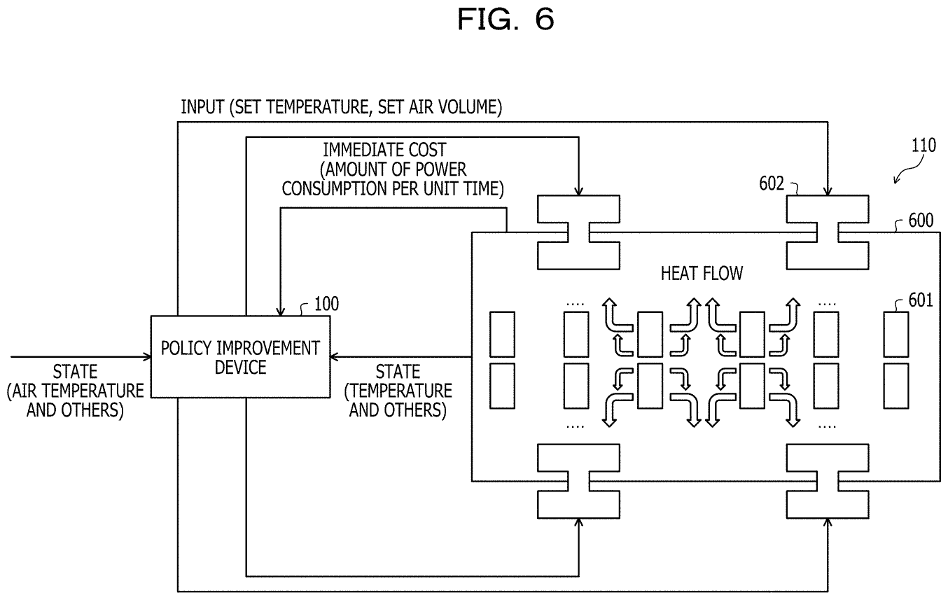

The control target 110 may be, for example, an air conditioning apparatus. In this case, the input is, for example, at least any of a set temperature of the air conditioning apparatus and a set air volume of the air conditioning apparatus. The state is, for example, at least any of a temperature inside a room with the air conditioning apparatus, a temperature outside the room with the air conditioning apparatus, and a climate. The cost is, for example, the power consumption of the air conditioning apparatus. The case where the control target 110 is an air conditioning apparatus is, for example, described later with reference to FIG. 6.

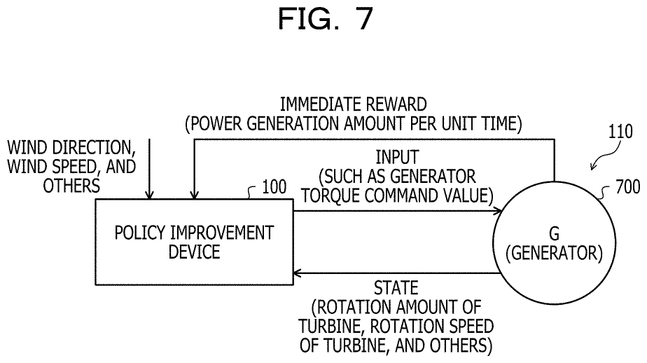

The control target 110 may be, for example, a power generation apparatus. The power generation apparatus is, for example, a wind power generation apparatus. In this case, the input is, for example, the generator torque of the power generation apparatus. The state is, for example, at least any of a power generation amount of the power generation apparatus, a rotation amount of a turbine of the power generation apparatus, a rotation speed of the turbine of the power generation apparatus, a wind direction with respect to the power generation apparatus, and a wind speed with respect to the power generation apparatus. The reward is, for example, the power generation amount of the power generation apparatus. The case where the control target 110 is a power generation apparatus is, for example, described later with reference to FIG. 7.

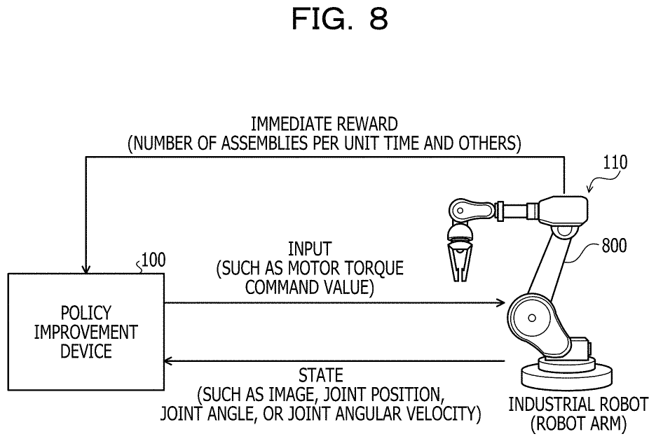

The control target 110 may be, for example, an industrial robot. In this case, the input is, for example, the motor torque of the industrial robot. The state is, for example, at least any of an image taken by the industrial robot, a joint position of the industrial robot, a joint angle of the industrial robot, and a joint angular velocity of the industrial robot. The reward is, for example, the production amount of the industrial robot. The production amount is the number of assemblies, for example. The number of assemblies is the number of products assembled by the industrial robot, for example. The case where the control target 110 is an industrial robot is, for example, described later with reference to FIG. 8.

The storage unit 400 may store the policy parameter. The storage unit 400 stores, for example, the policy parameter. The parameter is, for example, a feedback coefficient matrix. This allows the storage unit 400 to store the policy parameter to be updated at a predetermined timing. The storage unit 400 makes it possible for the respective functional units to refer to the policy parameter. The storage unit 400 may store the contraction function. Thus, the storage unit 400 makes it possible for the respective functional units to refer to the contraction function.

The observation unit 401 acquires various types of information used for the processing of the respective functional units. The observation unit 401 stores the acquired various types of information in the storage unit 400 or outputs the information to the respective functional units. The observation unit 401 may output the various types of information stored in the storage unit 400 to the respective functional units. For example, the observation unit 401 acquires various types of information based on an operational input by a user. The observation unit 401 may receive the various types of information from a device different from the policy improvement device 100.

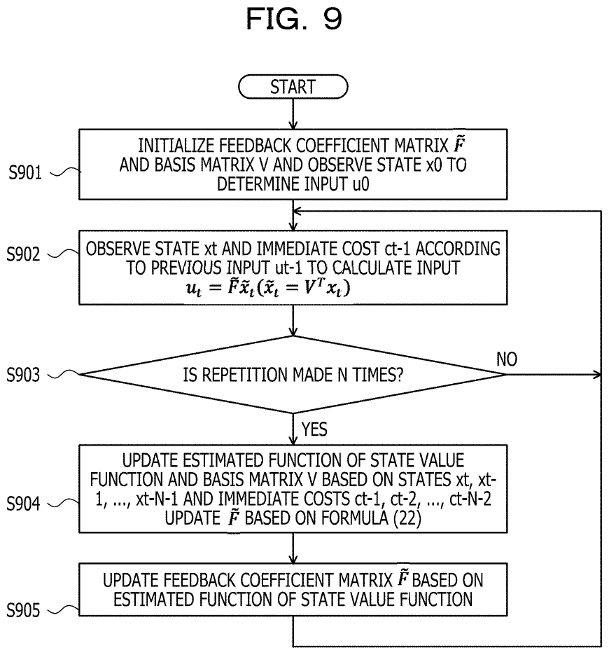

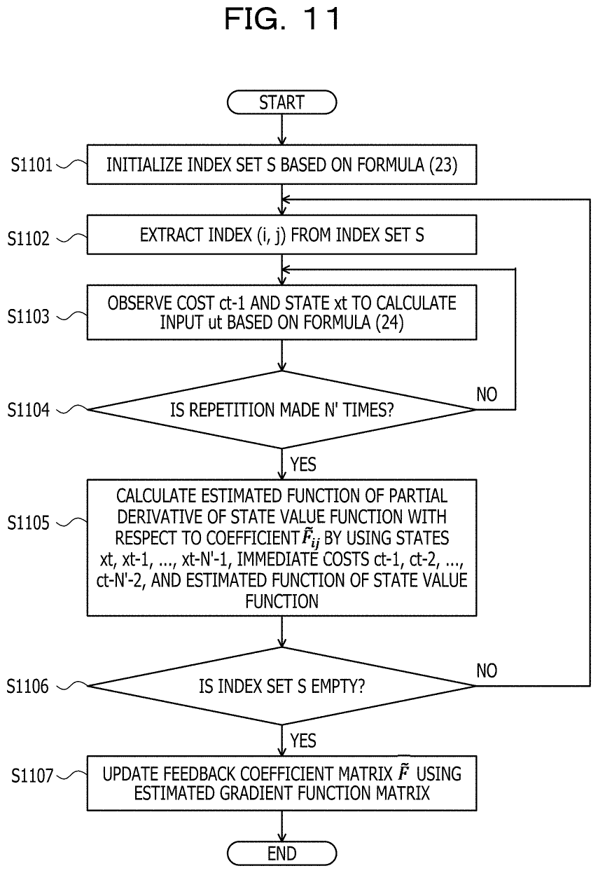

The observation unit 401 observes the state and the immediate cost or immediate reward of the control target 110, and outputs them to the storage unit 400. For example, the observation unit 401 observes the state of the control target 110 and the immediate cost or immediate reward in step S902 described later in FIG. 9 or step S1103 described later in FIG. 11. As a result, the observation unit 401 makes it possible for the storage unit 400 to accumulate the state and the immediate cost or immediate reward of the control target 110.

The contraction unit 402 calculates estimated parameters by estimating the parameters of the state value function for the state of the control target 110. The contraction unit 402 updates the estimated state value function by updating the estimated parameter of the estimated state value function using, for example, the collective least-squares method, the recursive least-squares method, the collective LSTD algorithm, or the recursive LSTD algorithm. Thus, the contraction unit 402 may refer to the estimated state value function in order to update the parameter that defines the policy. The contraction unit 402 may improve the state value function.

Regarding the collective least-squares method, the recursive least-squares method, the collective LSTD algorithm, the recursive LSTD algorithm, and the like, the following Reference Documents 2 and 3 may be referred to.

Reference Document 2: Y. Zhu and X. R. Li. Recursive least squares with linear constraints. Communications in Information and Systems, vol. 7, no. 3, pp. 287-312, 2007.

Reference Document 3: Christoph Dann and Gerhard Neumann and Jan Peters. Policy Evaluation with Temporal Differences: A Survey and Comparison. Journal of Machine Learning Research, vol. 15, pp. 809-883, 2014.

In the case of a linear problem, the contraction unit 402 generates an estimated coefficient matrix obtained by estimating the coefficient matrix of the state value function for the state of the control target 110. The contraction unit 402 updates the estimated state value function by updating the estimated coefficient matrix of the estimated state value function using, for example, the collective least-squares method, the recursive least-squares method, the collective LSTD algorithm, the recursive LSTD algorithm, or the like. For example, the contraction unit 402 updates the estimated state value function by updating the estimated coefficient matrix of the estimated state value function in step S904 to be described later in FIG. 9. Thus, the contraction unit 402 makes it possible to refer to the estimated state value function in order to update the feedback coefficient matrix that defines the policy. The contraction unit 402 may improve the state value function.

The contraction unit 402 contracts the state space of the control target 110 using the calculated estimated parameter. The contraction unit 402 contracts the state space of the control target 110 by updating the contraction function using the calculated estimated parameter, for example. Thus, the contraction unit 402 makes it possible to contract the state space the control target 110 by the contraction function and to perform efficient reinforcement learning.

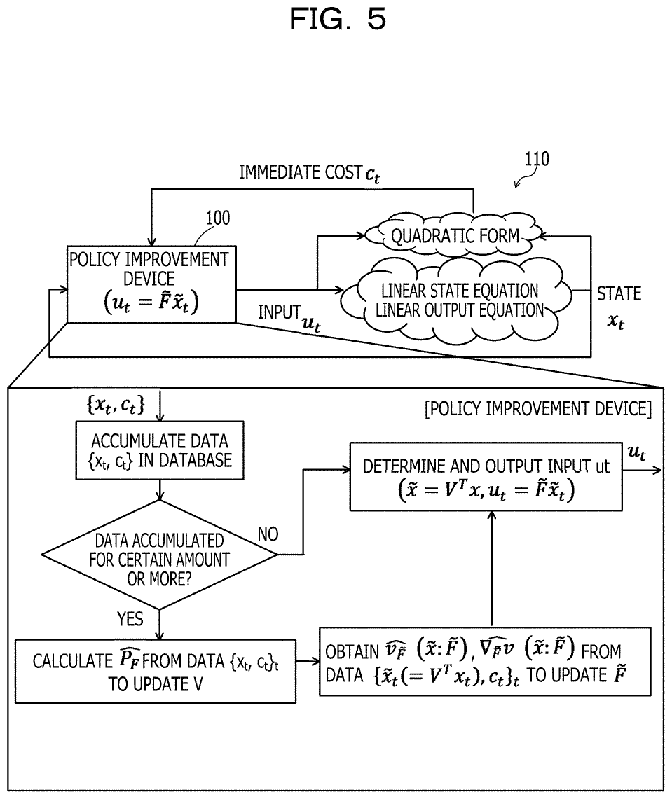

In the case of a linear problem, the contraction unit 402 contracts the state space of the control target 110 using the generated estimated coefficient matrix. For example, in step S904 to be described later in FIG. 9, the contraction unit 402 generates a basis matrix from the estimated coefficient matrix by diagonalization, singular value decomposition, or the like and generates a contraction matrix by removing a column whose eigenvalue or singular value is 0 from the columns of the basis matrix. A specific example of generating the contraction matrix is described later with reference to FIG. 5, for example. Thus, the contraction unit 402 makes it possible to contract the state space the control target 110 by the contraction function and to perform efficient reinforcement learning.

The update unit 403 generates a TD error with respect to the estimated state value function that estimates the state value function in the contracted state space of the control target 110 by perturbing each parameter that defines the policy. Thus, the update unit 403 may acquire the partial differential result indicating the degree of reaction to perturbation for each parameter that defines the policy.

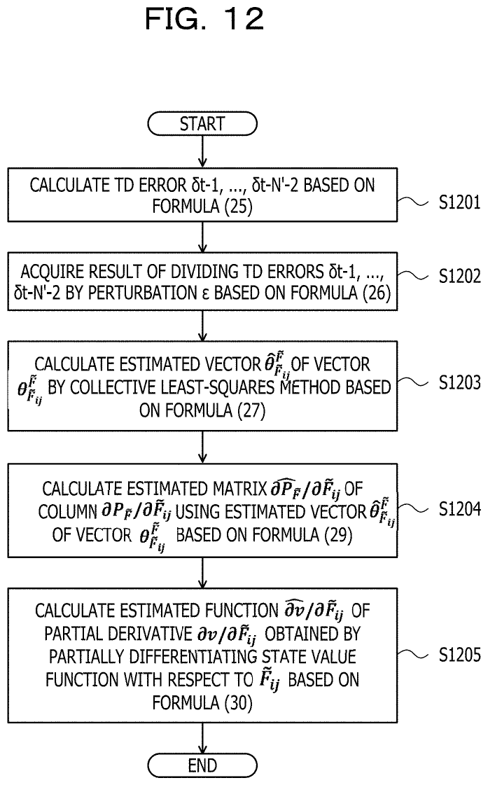

As for a linear problem, the update unit 403 generates a TD error with respect to an estimated state value function that estimates the state value function in the contracted state space of the control target 110 by perturbing each of the elements of the feedback coefficient matrix that defines the policy. In steps S1102 to S1104 to be described later in FIG. 11, for example, the update unit 403 perturbs each element of the feedback coefficient matrix that provides the policy. In step S1105 to be described later in FIG. 11 and step S1201 to be described later in FIG. 12, the update unit 403 generates a TD error with respect to the estimated state value function that estimates the state value function corresponding to the perturbation. Thus, the update unit 403 may acquire the partial differential result indicating the degree of reaction to the perturbation for each element of the feedback coefficient matrix.

The update unit 403 generates an estimated gradient that estimates the gradient of the state value function for the parameter that defines the policy, based on the generated TD error and the perturbation, in the contracted state space of the control target 110. The update unit 403 generates the estimated gradient based on the TD error and the perturbation, for example, by utilizing the fact that the immediate cost or the immediate reward is defined by the state and the input. Accordingly, the update unit 403 may update the parameter of the policy based on the estimated gradient.

As for a linear problem, the update unit 403 generates an estimated gradient function matrix that estimates a gradient function matrix of the state value function for the feedback coefficient matrix, based on the generated TD error and the perturbation, in the contracted state space of the control target 110. The update unit 403 generates the estimated gradient function matrix based on the TD error and the perturbation, for example, by utilizing the fact that the state change of the control target 110 is defined by a linear difference equation and that the immediate cost or immediate reward of the control target 110 is defined by the quadratic form of the state and the input.

For example, the update unit 403 associates the result of dividing the TD error generated for each element of the feedback coefficient matrix by perturbation with the result of differentiating the state value function with respect to each element of the feedback coefficient matrix, and generates an estimated element that estimates each element of the gradient function matrix. The update unit 403 defines the result of differentiating the state value function with respect to each element of the feedback coefficient matrix as the product of the state-dependent vector and the state-independent vector.

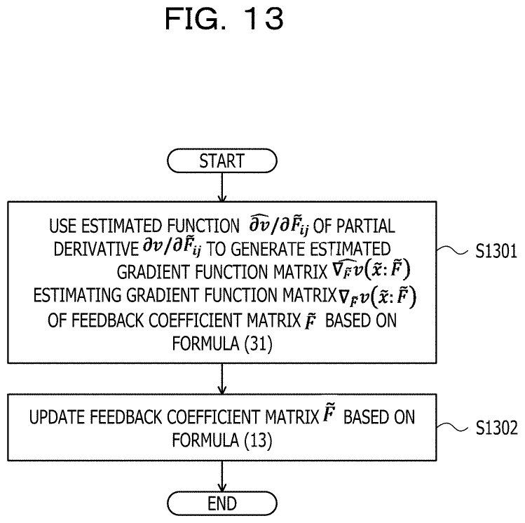

For example, in steps S1202 to S1205 to be described later in FIG. 12, the update unit 403 generates an estimated element that estimates each element of the gradient function matrix in a format in which an arbitrary state may be substituted. The update unit 403 then generates an estimated gradient function matrix obtained by estimating the gradient function matrix in step S1301 to be described later in FIG. 13. The update unit 403 uses formula (27) to be described later, which is formed by associating the result of dividing the TD error generated for each element of the feedback coefficient matrix by the perturbation with the result of differentiating the state value function with respect to each element of the feedback coefficient matrix.

The update unit 403 may use the collective least-squares method, the recursive least-squares method, the collective LSTD algorithm, the recursive LSTD algorithm, or the like when generating the estimated elements which estimates the respective elements of the gradient function matrix. Accordingly, the update unit 403 may generate the estimated gradient function matrix into which any state may be substituted. The update unit 403 may also update the feedback coefficient matrix based on the estimated gradient function matrix.

The update unit 403 uses the generated estimated gradient to update the parameter that defines the policy. The update unit 403 uses the estimated gradient according to the above formula (2), for example, to update the parameter that defines the policy. Accordingly, the update unit 403 may update the parameter that defines the policy based on the estimated gradient, thereby improving the policy.

As for a linear problem, the update unit 403 uses the generated estimated gradient function matrix to update the feedback coefficient matrix. The update unit 403 uses the estimated gradient function matrix to update the feedback coefficient matrix in step S1302 to be described later in FIG. 13, for example. As a result, the update unit 403 may update the feedback coefficient matrix based on the estimated value of the estimated gradient function matrix into which state is substituted, thereby improving the policy.

The determination unit 404 determines an input value for the control target 110 based on the policy using the updated parameters, and outputs the input value to the control target 110. Thus, the determination unit 404 may determine the input value that may optimize the cumulative cost and cumulative reward, and may control the control target 110.

As for a linear problem, the determination unit 404 determines an input value for the control target 110 based on the policy using the updated feedback coefficient matrix, and outputs the input value to the control target 110. Thus, the determination unit 404 may determine the input value that may optimize the cumulative cost and cumulative reward, and may control the control target 110.

The output unit 405 outputs the processing result of at least any of the functional units. Examples of the output format include, for example, display on a display, printing output to a printer, transmission to an external device by the network I/F 203, and storing in a storage region, such as the memory 202 or the recording medium 205. The output unit 405 outputs, for example, the updated policy. The output unit 405 outputs, for example, the parameter of the updated policy. For example, the output unit 405 outputs the updated feedback coefficient matrix. Thus, the output unit 405 makes it possible for another computer to control the control target 110.

(Example of Reinforcement Learning)

Next, an example of reinforcement learning is described with reference to FIG. 5.

FIG. 5 is an explanatory diagram illustrating an example of reinforcement learning. This example corresponds to the case where the control target 110 is a linear system and the problem that is solved by reinforcement learning and that represents the control target 110 is a linear problem.

In the example, the state change of the control target 110 is defined by a linear difference equation, and the immediate cost or immediate reward of the control target 110 is defined by the quadratic form of the state of the control target 110 and the input to the control target 110. For example, the following formulas (3) to (11) define the state equation of the control target 110, the quadratic form equation of the immediate cost, and the policy, and sets the problem. In the example, the state of the control target 110 is directly observable.

xₜ₊₁Axₜ+Buₜ (3)

The above formula (3) is a state equation of the control target 110. The value t is a time indicated by a multiple of the unit time. The value t+1 is the next time after a unit time has elapsed from the time t. The symbol xₜ₊₁ is the state at the next time t+1. The symbol xₜ is the state at the time t. The symbol uₜ is the input at the time t. A and B are coefficient matrices. The above formula (3) indicates that the state xₜ₊₁ at the next time t+1 has a relationship determined by the state xₜ at the time t and the input uₜ at the time t. The coefficient matrices A and B are unknown.

x₀ϵ [symbol] ² (4)

The above formula (4) indicates that the state x₀ is n-dimensional. The value n is known.

uₜϵ [symbol] ^{m},t=0,1,2 (5)

The above formula (5) indicates that the input uₜ is m-dimensional.

Aϵ [symbol] ^{n×n},Bϵ [symbol] ^{n×m} (6)

The above formula (6) indicates that the coefficient matrix A has n×n dimensions (n rows and n columns), and the coefficient matrix B has n×m dimensions (n rows and m columns).

cₜ=c(xₜ,uₜ)=xₜ^{T}Qxₜ+uₜ^{T}Ruₜ (7)

The above formula (7) is an equation that defines the immediate cost of the control target 110. The symbol cₜ is an immediate cost which occurs after the unit time according to the input uₜ at the time t. A superscript T represents transposition. The above formula (7) indicates that the immediate cost cₜ has a relationship determined by the quadratic form of the state xₜ at the time t and the input uₜ at the time t. The coefficient matrices Q and R are unknown. The immediate cost cₜ is directly observable.

Qϵ [symbol] ^{n×n},Q=Q_{T}≥0,Rϵ [symbol] ^{m×m},R=R^{T}>0 (8)

The above formula (8) indicates that the coefficient matrix Q has n×n dimensions. The “≥0” represents a positive-semidefinite symmetric matrix. The above formula (8) indicates that the coefficient matrix R has m×m dimensions. The “>0” represents a positive definite symmetric matrix.

uₜ=F̅\tilde{x}ₜ (9)

The above formula (9) represents the policy. The symbol F\tilde{ } is a feedback coefficient matrix and represents a coefficient matrix related to the state xₜ. The above formula (9) is an equation which determines the input uₜ at the time t based on the state xₜ at the time t.

\tilde{F}ϵ [symbol] ^{m×n′},t=0,1,2, . . . (10)

The above formula (10) indicates that the feedback coefficient matrix F\tilde{ } has m×n′ dimensions.

v(x:F)=x^{T}P_{F}x (11)

The above formula (11) represents a state value function. When the state change of the control target 110 is defined by a linear difference equation, and the immediate cost or immediate reward of the control target 110 is defined by the quadratic form of the state of the control target 110 and the input to the control target 110, the state value function is expressed in a quadratic form as in the above formula (11). P_{F} is a coefficient matrix of the state value function.

The policy improvement device 100 stores a contraction matrix V that contracts an n-dimensional state x to an n′-dimensional state x\tilde{ }. The contraction matrix V is an nxn′-dimensional matrix. Here, n>n′. The contraction matrix V is, for example, an identity matrix in the initial state. Next, description is given of the flow in which the policy improvement device 100 contracts the space X in the state x and updates the feedback coefficient matrix F\tilde{ }.

In FIG. 5, (5-1) the policy improvement device 100 generates an estimated coefficient matrix P\tilde{ }_{F} by estimating the coefficient matrix P_{F} of the state value function v(x:F). For convenience, for example, a symbol with “\hat{ }” added to the upper part of P_{F} described in the drawings, formulas, and the like is expressed as “P\hat{ }_{F}” in the description.

The policy improvement device 100 stores data {xₜ, cₜ} in the database every time the data is acquired, for example. The policy improvement device 100 repeatedly contracts the state xₜ to the state x″ₜ and determines the input uₜ to be outputted to the control target 110, based on the current policy uₜ=F\tilde{ }x\tilde{ }ₜ and the current contraction matrix V until a certain amount or more of data {xₜ, cₜ} is accumulated. Thus, the policy improvement device 100 acquires new data {xₜ, cₜ}. Thereafter, when a certain amount or more of data {xₜ, cₜ} is accumulated, the policy improvement device 100 generates an estimated coefficient matrix P\tilde{ }_{F} from the accumulated data {xₜ, cₜ}ₜ.

(5-2) The policy improvement device 100 uses the generated estimated coefficient matrix P\tilde{ }_{F} to contract the space X of the state x of the control target 110. The policy improvement device 100 updates the contraction matrix V using, for example, the generated estimated coefficient matrix P\tilde{ }_{F} to contract the space X of the state x of the control target 110 to the space X\tilde{ } of the state x\tilde{ } of the control target 110.

For example, the policy improvement device 100 performs diagonalization, singular value decomposition, or the like on the estimated coefficient matrix P\tilde{ }_{F} according to the following formula (12) to generate a basis matrix V₀. The policy improvement device 100 generates a new contraction matrix V as a result of removing the column in which the corresponding eigenvalue or singular value of is 0 from the columns of the basis matrix V₀, thereby updating the current contraction matrix V. The policy improvement device 100 uses the updated contraction matrix V to contract the space X of the state x of the control target 110 to the space X\tilde{ } of the state x\tilde{ } of the control target 110.

[symbol]

=V₀ΣV₀^{T} (12)

(5-3) The policy improvement device 100 generates an estimated gradient function matrix ∇\hat{ }_{f\tilde{ }}v(x\tilde{ }:F\tilde{ }) by estimating the gradient function matrix ∇_{F\tilde{ }}v(x\tilde{ }:F\tilde{ }) of the state value function v(x:F) related to the feedback coefficient matrix F\tilde{ } with respect to the space X\tilde{ } of the state x\tilde{ } of the contracted control target 110. For convenience, a symbol with a subscript F\tilde{ } added to ∇ described in the drawings, formulas, and the like, for example, is expressed as “∇F\tilde{ }” in the description. For convenience, a symbol with “\hat{ }” added to the upper part of ∇F\tilde{ }v described in the drawings, formulas, and the like, for example, is expressed as “∇\hat{ }_{F\tilde{ }v” in the description.}

For example, the policy improvement device 100 obtains the estimated state value function v\hat{ }_{F\tilde{ }}(x\tilde{ }:F\tilde{ }) from the data {(x\tilde{ }ₜ=V^{T}xₜ), cₜ}ₜ in the space X\tilde{ } of the contracted state x\tilde{ } of the control target 110, and then obtains the estimated gradient function matrix ∇\hat{ }_{F\tilde{ }}v(x\tilde{ }:F\tilde{ }). For convenience, a symbol with a subscript F\tilde{ } added to v described in the drawings, formulas, and the like, for example, is expressed as “v_{F\tilde{ }}” in the description. For convenience, a symbol with “\hat{ }” added to the upper part of v_{F\tilde{ }} described in the drawings, formulas, and the like, for example, is expressed as “v_{F\tilde{ }}v” in the description.

For example, the policy improvement device 100 perturbs each of the elements of the feedback coefficient matrix F\tilde{ } to collect the data {(x″ₜ=∇^{T}xₜ), cₜ}ₜ for the contracted space X\tilde{ } of the state x\tilde{ } of the control target 110. Next, the policy improvement device 100 obtains the estimated state value function v\hat{ }_{F\tilde{ }}(x\tilde{ }:F\tilde{ }) from the collected data {(x\tilde{ }ₜ=V^{T}xₜ), cₜ}ₜ, and generates a TD error for the estimated state value function v\hat{ }_{F\tilde{ }}(x\tilde{ }:F\tilde{ }). The policy improvement device 100 generates an estimated gradient function matrix ∇\hat{ }_{F\tilde{ }}v(x\tilde{ }:F\tilde{ }) based on the generated TD error and the perturbation.

(5-4) The policy improvement device 100 uses the generated estimated gradient function matrix ∇\hat{ }_{F\tilde{ }}v(x\tilde{ }:F\tilde{ }) to update the feedback coefficient matrix F\tilde{ } that defines the policy. The policy improvement device 100 uses the generated estimated gradient function matrix ∇\hat{ }_{F\tilde{ }}v(x\tilde{ }:F\tilde{ }), for example, to update the feedback coefficient matrix F\tilde{ } that defines the policy according to the following formula (13). The following formula (13) is an update rule corresponding to the case of using an immediate cost for reinforcement learning, for example. The value a is a weight.

$$\tilde{F} ← \hat{F} - α ( {\sum }_{k = 1}^{M} ( {\tilde{x}}^{[ k ]} \text{:} \tilde{F} ) ) \qquad ( 13 )$$

When using the immediate reward for the reinforcement learning, the policy improvement device 100 uses the generated estimated gradient function matrix ∇\hat{ }_{F\tilde{ }}v(x\tilde{ }:F\tilde{ }) to update the feedback coefficient matrix F\tilde{ } that defines the policy according to the following formula (14). The value a is a weight.

$$\tilde{F} ← \hat{F} + α ( {\sum }_{k = 1}^{M} ( {\tilde{x}}^{[ k ]} \text{:} \tilde{F} ) ) \qquad ( 14 )$$

(5-5) The policy improvement device 100 calculates an input uₜ based on the updated policy uₜ=F\tilde{ }x\tilde{ }ₜ and the updated contraction matrix V, and outputs the input to the control target 110. Thus, the policy improvement device 100 may control the control target 110 according to the updated policy uₜ=F\tilde{ }x\tilde{ }ₜ. Next, description is given of a specific example where the policy improvement device 100 generates the estimated gradient function matrix ∇\hat{ }_{F\tilde{ }}v(x\tilde{ }:F\tilde{ }) to update the feedback coefficient matrix F\tilde{ }.

<Specific Example where Policy Improvement Device 100 Updates Feedback Coefficient Matrix F\tilde{ }>

The policy improvement device 100 perturbs the elements F\tilde{ }ᵢⱼ of (i, j) of the feedback coefficient matrix F\tilde{ } in the space X\tilde{ } of the contracted state x\tilde{ } of the control target 110. For convenience, a symbol with added to the upper part of Fᵢⱼ described in the drawings, formulas, and the like, for example, is expressed as “F\tilde{ }ᵢⱼ” in the description. The (i, j) is an index that specifies a matrix element. The index (i, j) specifies, for example, the element on the i-th row and the j-th column of the feedback coefficient matrix F\tilde{ }.

For example, the policy improvement device 100 perturbs to the (i, j) element F\tilde{ }ᵢⱼ of the feedback coefficient matrix F\tilde{ } according to the formula of the feedback coefficient matrix F\tilde{ }+ϵE\tilde{ }ᵢⱼ. For convenience, a symbol with ˜ added to the upper part of Eᵢⱼ described in the drawings, formulas, and the like, for example, is expressed as “E\tilde{ }ᵢⱼ” in the description. E\tilde{ }ᵢⱼ is an mxn′-dimensional matrix in which the element specified by the index (i, j) is 1 and the other elements are 0. ϵ is a real number.

The policy improvement device 100 uses the perturbed feedback coefficient matrix F\tilde{ }+εE\tilde{ }ᵢⱼ, instead of the feedback coefficient matrix F\tilde{ } in the above formula (9) to generate the input. The TD error may be represented by the partial differential coefficient of the state value function with respect to the (i, j) element F\tilde{ }ᵢⱼ of the feedback coefficient matrix F\tilde{ }.

Since the state value function is represented in a quadratic form as in the above formula (11), the function ∂v/∂F\tilde{ }ᵢⱼ(x\tilde{ }:F\tilde{ }), which is obtained by partially differentiating the state value function with respect to the (i, j) element F\tilde{ }ᵢⱼ of the feedback coefficient matrix F\tilde{ }, is represented in a quadratic form as in the following formula (15). In the following description, the function which is obtained by partially differentiating may be referred to as a “partial derivative”.

$$\frac{\partial v}{\partial {\tilde{F}}_{ij}} ( \tilde{x} \text{:} \tilde{F} ) = \tilde{x} \frac{\partial {\tilde{F}}_{ij}}{} \tilde{x} \qquad ( 15 )$$

The policy improvement device 100 uses the above formula (15) to calculate an estimated function ∂v\hat{ }/∂F\tilde{ }ᵢⱼ(x\tilde{ }:F\tilde{ }) by estimating the partial derivative ∂v/∂F\tilde{ }ᵢⱼ(x\tilde{ }:F\tilde{ }) of the (i, j) element F\tilde{ }ᵢⱼ of the feedback coefficient matrix F\tilde{ }. For convenience, a symbol with \hat{ } added to the upper part of ∂v/∂F\tilde{ }ᵢⱼ described in the drawings, formulas, and the like, for example, is expressed as “∂v\hat{ }/∂F\tilde{ }ᵢⱼ” in the description. The estimated function ∂v\hat{ }/∂F\tilde{ }ᵢⱼ(x\tilde{ }:F\tilde{ }) may be described as in the following formula (16) by adding \hat{ } to the upper part of the partial derivative ∂v/∂F\tilde{ }ᵢⱼ (X\tilde{ }:F\tilde{ }).

$$\frac{\partial {\tilde{F}}_{ij}}{} ( \tilde{x} \text{:} \tilde{F} ) \qquad ( 16 )$$

The policy improvement device 100 perturbs each element of the feedback coefficient matrix F\tilde{ } to similarly calculate an estimated function ∂v\hat{ }/∂F\tilde{ }ᵢⱼ (x\tilde{ }:F\tilde{ }) by estimating the partial derivative ∂v/∂F\tilde{ }ᵢⱼ (x\tilde{ }:F\tilde{ }). The policy improvement device 100 uses the estimated function ∂v\hat{ }/∂F\tilde{ }ᵢⱼ (x\tilde{ }:F\tilde{ }) thus calculated to generate an estimated gradient function matrix ∇\hat{ }_{F\tilde{ }}v(x\tilde{ }:F\tilde{ }) by estimating the gradient function matrix ∇F\tilde{ }v(x\tilde{ }:F\tilde{ }) of the feedback coefficient matrix F\tilde{ }. Hereinafter, the estimated gradient function matrix ∇\hat{ }_{F\tilde{ }}v(x\tilde{ }:F\tilde{ }) may be described as in the following formula (17), for example, by adding \hat{ } to the upper part of the gradient function matrix ∇F\tilde{ }v(x\tilde{ }:F\tilde{ }).

[symbol]

(\tilde{x}:\tilde{F}) (17)

Accordingly, the policy improvement device 100 may calculate the estimated gradient function matrix ∇\hat{ }_{F\tilde{ }}v(x\tilde{ }:F\tilde{ }) at any given time by estimating the gradient function matrix ∇F\tilde{ }v(x\tilde{ }:F\tilde{ }) in the form in which an arbitrary state x may be substituted. After that time, in the case of calculating an estimated value of the gradient function matrix ∇F\tilde{ }v(x\tilde{ }:F\tilde{ }) for a certain state x, the policy improvement device 100 may only substitute the state x into the calculated estimated gradient function matrix ∇\hat{ }_{F\tilde{ }}v(x\tilde{ }:F\tilde{ }).

Accordingly, the policy improvement device 100 may generate an estimated gradient function matrix ∇\hat{ }_{F\tilde{ }}v(x\tilde{ }:F\tilde{ }) that estimates the gradient function matrix ∇F\tilde{ }v(x\tilde{ }:F\tilde{ }) that is usable after a certain time, rather than the estimated value of the gradient function matrix ∇F\tilde{ }v(x\tilde{ }:F\tilde{ }) for a certain state x. Therefore, the policy improvement device 100 is capable of relatively easily calculating the estimated value of the gradient function matrix ∇F\tilde{ }v(x\tilde{ }:F\tilde{ }) for various states x, and reducing the processing amount.

As a result, the policy improvement device 100 is capable of reducing the number of elements of the feedback coefficient matrix F\tilde{ } that defines the policy even when the problem representing the control target 110 is not linear or the problem representing the control target 110 is unknown. Therefore, the policy improvement device 100 is capable of improving the learning efficiency in the reinforcement learning and reducing the processing time taken for the reinforcement learning.

Next, the validity of contracting the state space is described. In the above description, the estimated coefficient matrix P\hat{ }_{F} obtained by estimating the coefficient matrix P_{F} of the state value function v(x:F) is used to generate the contraction matrix V. The coefficient matrix P_{F} and the feedback coefficient matrix F have the relationship represented by the following formula (18), and therefore the coefficient matrix P_{F} is not irrelevant to the feedback coefficient matrix F but has a relatively strong relationship with the feedback coefficient matrix F.

P_{F}=Σₛ₌₀^{∞}γ^{s}{(A+BF)^{T}}^{s}(Q+F^{T}RF){A+BF}^{s} (18)

The estimated coefficient matrix P\hat{ }_{F} is a matrix directly estimated from actual data. For example, the estimated coefficient matrix P\hat{ }_{F} is a matrix that is estimated directly from the actual data of the past states x₁, . . . and the past immediate costs c₁, . . . , by using least squares method and is not irrelevant to the control target 110 but has a relationship with the control target 110.

Since the coefficient matrix P_{F} has a relatively strong relationship with the feedback coefficient matrix F, contracting the coefficient matrix P_{F} and contracting the feedback coefficient matrix F have a relationship. For example, the following formula (19) is established in which the left side representing the contraction of the coefficient matrix P_{F} and the right side representing the contraction of the feedback coefficient matrix F are equal. Therefore, when the space X of the state x may be contracted by the contraction matrix V, the space may be contracted by V±P_{F}V. Here, the superscript + indicates a pseudo inverse matrix.

V⁺P_{F}V=Σₛ₌₀^{∞}γ^{s}{(Ã+\tilde{B}\tilde{F})^{T}}^{s}(\tilde{Q}+\tilde{F}^{T}\tilde{R}\tilde{F}){(Ã+\tilde{R}\tilde{F}}^{s} (19)

The transition matrix A+BF is related to the linear system that is the control target 110 according to the following formula (20), and the objective function Q+F^{T}RF is related to the objective function according to the following formula (21). According to the above formula (18), the coefficient matrix P_{F} is defined using the transition matrix A+BF and the objective function Q+F^{T}RF. γ is a coefficient.

xₖ₊₁=Axₖ+Buₖ(A+BF)xₖ (20)

xₖ^{T}Qxₖ+uₖ^{T}Ruₖ=ₓ^{T}(Q+F^{T}RF)xₖ (21)

Therefore, when the ranks of both the transition matrix A+BF and the objective function Q+F^{T}RF are small, there is a property that the rank of the coefficient matrix P_{F} is also small. For example, when both the transition matrix A+BF and the objective function Q+F^{T}RF may be contracted, the coefficient matrix P_{F} may also be contracted. From the above, it is considered that the use of the estimated coefficient matrix P\hat{ }_{F} makes it easier to obtain the contraction matrix V suitable for the purpose of contracting the state space and contracting the feedback coefficient matrix F.

(Specific Example of Control Target 110)

Next, a specific example of the control target 110 is described with reference to FIGS. 6 to 8.

FIGS. 6 to 8 are explanatory diagrams illustrating specific examples of the control target 110. In the example of FIG. 6, the control target 110 is a server room 600 including a server 601 that is a heat source and a cooler 602, such as a computer room air conditioner (CRAC) or Chiller. The inputs are the set temperature and the set air volume for the cooler 602. The state is sensor data from a sensor device provided in the server room 600, such as the temperature. The state may be data related to the control target 110 obtained from a target other than the control target 110, and may be, for example, temperature or weather. The immediate cost is an amount of power consumption per unit time by the server room 600, for example. The unit time is set to 5 minutes, for example. A goal is to minimize accumulated power consumption by the server room 600. The state value function represents, for example, the state value of the accumulated power consumption of the server room 600.

The policy improvement device 100 may update the feedback coefficient matrix F so that the accumulated power consumption, which is the cumulative cost, is efficiently minimized with the reduced number of elements of the feedback coefficient matrix F. Therefore, the policy improvement device 100 is capable of reducing the time taken until the accumulated power consumption of the control target 110 is minimized, and reducing the operating cost of the server room 600. Even in a case where a change in the use status of the server 601, a change in temperature, or the like occurs, the policy improvement device 100 is capable of efficiently minimizing the accumulated power consumption in a relatively short period of time from the change.

A description has been provided for the case where the immediate cost is the power consumption per unit time of the server room 600, but the embodiment is not limited thereto. The immediate cost may be, for example, the sum of squares of the error between the target room temperature of the server room 600 and the current room temperature. The target may be, for example, to minimize the accumulated value of the sum of squares of the error between the target room temperature of the server room 600 and the current room temperature. The state value function represents, for example, the state value regarding the error between the target room temperature and the current room temperature.

In the example of FIG. 7, the control target 110 is a generator 700. The generator 700 is, for example, a wind generator. The input is a command value for the generator 700. The command value is, for example, a generator torque. The state is sensor data from the sensor device provided in the generator 700, and is, for example, the power generation amount of the power generator 700, the rotation amount or rotation speed of the turbine of the generator 700, or the like. The state may be a wind direction, wind speed, or the like with respect to the generator 700. The immediate reward is, for example, the power generation amount of the generator 700 per unit time. The unit time is set to 5 minutes, for example. The target is, for example, to maximize the accumulated power generation amount of the power generator 700. The state value function represents, for example, the state value of the accumulated power generation amount of the generator 700.

The policy improvement device 100 may update the feedback coefficient matrix F so that the accumulated power generation amount, which is the cumulative reward, is efficiently maximized with the reduced number of elements of the feedback coefficient matrix F. Therefore, the policy improvement device 100 is capable of reducing the time taken until the accumulated power generation amount of the control target 110 is maximized, and increasing the profit of the generator 700. Even in a case where a change in the status of the generator 700 or the like occurs, the policy improvement device 100 is capable of efficiently maximizing the accumulated power generation amount in a relatively short period of time from the change.

In the example of FIG. 8, the control target 110 is an industrial robot 800. The industrial robot 800 is a robot arm, for example. The input is a command value for the industrial robot 800. The command value is motor torque of the industrial robot 800, for example. The state is sensor data from a sensor device provided to the industrial robot 800, examples of which include a shot image of the industrial robot 800, a joint position, a joint angle, a joint angular velocity of the industrial robot 800, and the like. The immediate reward is, for example, the number of assemblies of the industrial robot 800 per unit time. A goal is to maximize productivity of the industrial robot 800. The state value function represents, for example, the state value of the accumulated number of assemblies of the industrial robot 800.

The policy improvement device 100 may update the feedback coefficient matrix F so that the accumulated number of assemblies, which is the cumulative reward, is efficiently maximized with the reduced number of elements of the feedback coefficient matrix F. Therefore, the policy improvement device 100 is capable of reducing the time taken until the accumulated number of assemblies of the control target 110 is maximized, and increasing the profit of the industrial robot 800. Even in a case where a change in the status of the industrial robot 800 or the like occurs, the policy improvement device 100 is capable of efficiently maximizing the accumulated number of assemblies in a relatively short period of time from the change.

The control target 110 may be a simulator of the specific example described above. The control target 110 may be a power generation apparatus other than wind power generation. The control target 110 may be, for example, a chemical plant or the like. The control target 110 may be, for example, an autonomous mobile body or the like. The autonomous mobile body is, for example, a drone, a helicopter, an autonomous mobile robot, an automobile, or the like. The control target 110 may be a game.

(Example of Reinforcement Learning Processing Procedure)

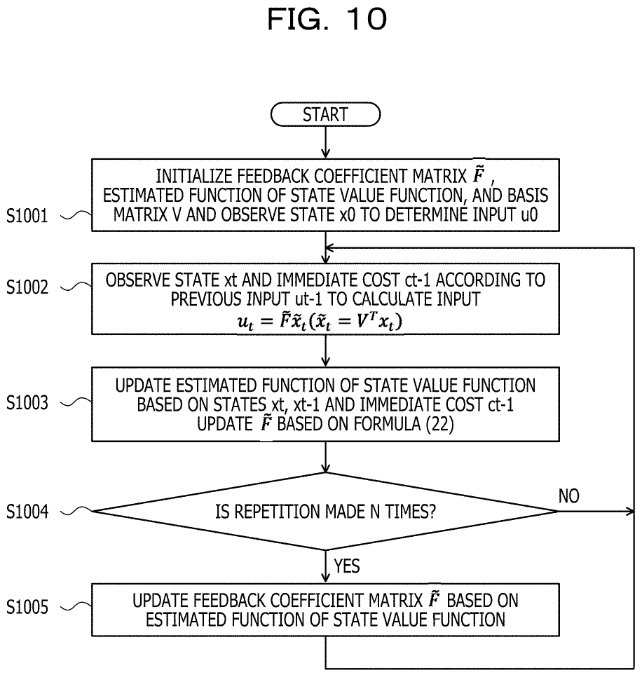

Next, an example of the reinforcement learning processing procedure is described with reference to FIGS. 9 and 10.

FIG. 9 is a flowchart illustrating an example of a batch processing format reinforcement learning processing procedure. In FIG. 9, first, the policy improvement device 100 initializes the feedback coefficient matrices F\tilde{ } and the basis matrix V and observes the state x₀ to determine the input u₀ (step S901). The basis matrix V is initialized to an identity matrix, for example. The basis matrix V is treated as a contraction matrix V and updated.

The policy improvement device 100 observes the state xₜ and the immediate cost cₜ₋₁ according to the previous input uₜ₋₁, and calculates the input uₜ=F\tilde{ }x\tilde{ }ₜ(x\tilde{ }ₜ=V^{T}xₜ) (step S902). The policy improvement device 100 determines whether or not step S902 has been repeated N times (step S903).

When step S902 has not been repeated N times (step S903: No), the policy improvement device 100 returns to the process of step S902. On the other hand, when step S902 has been repeated N times (step S903: Yes), the policy improvement device 100 proceeds to the process of step S904.

The policy improvement device 100 updates the estimated function of the state value function and the basis matrix V based on the states xₜ, xₜ₋₁, . . . , x_{t-N-1} and the immediate costs cₜ₋₁, cₜ₋₂, c_{t-N-2}. The policy improvement device 100 updates the feedback coefficient matrix F\tilde{ } based on the following formula (22) (step S904). V_{old} is the basis matrix V before updating, and V_{new} is the basis matrix V after updating.

\tilde{F}←\tilde{F}V_{old}^{T}V_{new}(V_{new}^{T}−V_{new})⁻¹ (22)

The policy improvement device 100 updates the feedback coefficient matrix F\tilde{ } based on the estimated function of the state value function (step S905). The policy improvement device 100 returns to the process of step S902. Accordingly, the policy improvement device 100 is capable of controlling the control target 110.

FIG. 10 is a flowchart illustrating an example of a sequential processing format reinforcement learning processing procedure. In FIG. 10, first, the policy improvement device 100 initializes the feedback coefficient matrix F\tilde{ }, the estimated function of the state value function, and the basis matrix V and observes the state x₀ to determines the input u₀ (step S1001). The basis matrix V is initialized to an identity matrix, for example. The basis matrix V is treated as a contraction matrix V and updated.

Next, the policy improvement device 100 observes the state xₜ and the immediate cost cₜ₋₁ according to the previous input uₜ₋₁, and calculates the input uₜ=F\tilde{ }x\tilde{ }ₜ(x\tilde{ }ₜ=V^{T}xₜ) (step S1002). The policy improvement device 100 updates the estimated function of the state value function and the basis matrix V based on the states xₜ and xₜ₋₁ and the immediate cost cₜ₋₁, and updates the feedback coefficient matrix F\tilde{ } based on the above formula (22) (step S1003).

The policy improvement device 100 determines whether or not step S1003 has been repeated N times (step S1004). When step S1003 has not been repeated N times (step S1004: No), the policy improvement device 100 returns to the process of step S1002. On the other hand, when step S1003 has been repeated N times (step S1004: Yes), the policy improvement device 100 proceeds to the process of step S1005.

The policy improvement device 100 updates the feedback coefficient matrix F\tilde{ } based on the estimated function of the state value function (step S1005). The policy improvement device 100 returns to the process of step S1002. Accordingly, the policy improvement device 100 is capable of controlling the control target 110.

(Example of Policy Improvement Processing Procedure)

Next, with reference to FIG. 11, description is given of an example of a policy improvement processing procedure, which is a specific example of step S905, in which the policy improvement device 100 updates the feedback coefficient matrix F\tilde{ } to improve the policy.

FIG. 11 is a flowchart illustrating an example of policy improvement processing procedures. In FIG. 11, the policy improvement device 100 first initializes the index set S based on the following formula (23) (step S1101).

S={(i,j)|iϵ{1,2, . . . ,m},jϵ{1,2, . . . ,n′}} (23)

The (i, j) is an index that specifies a matrix element. The index (i, j) specifies, for example, the element on the i-th row and the j-th column of the matrix. In the following description, m is the number of rows of the feedback coefficient matrix F\tilde{ }. n is the number of columns of the feedback coefficient matrix F\tilde{ }.

Next, the policy improvement device 100 extracts the index (i, j) from the index set S (step S1102). The policy improvement device 100 observes the cost cₜ₋₁ and the state xₜ, and calculates the input uₜ based on the following formula (24) (step S1103).

uₜ=(\tilde{F}+ε\tilde{E}ᵢⱼ)\tilde{x}ₜ (24)

The policy improvement device 100 determines whether or not step S1103 has been repeated N′ times (step S1104). When step S1103 has not been repeated N′ times (step S1104: No), the policy improvement device 100 returns to the process of step S1103. On the other hand, when step S1103 has been repeated N′ times (step S1104: Yes), the policy improvement device 100 proceeds to the process of step S1105.

The policy improvement device 100 calculates the estimated function of the partial derivative of the state value function with respect to the coefficient F\tilde{ }ᵢⱼ by using the states xₜ, xₜ₋₁, x_{t-N′-1}, the immediate costs cₜ₋₁, cₜ₋₂, . . . , c_{t-N′-2}, and the estimated function of the state value function (step S1105).

The policy improvement device 100 determines whether or not the index set S is empty (step S1106). When the index set S is not empty (step S1106: No), the policy improvement device 100 returns to the process of step S1102. On the other hand, when the index set S is empty (step S1106: Yes), the policy improvement device 100 proceeds to the process of step S1107.

The policy improvement device 100 updates the feedback coefficient matrix F\tilde{ } based on the estimated gradient function matrix (step S1107). The policy improvement device 100 then terminates the policy improvement processing. A description has been provided for the case where the policy improvement device 100 calculates the input uₜ by perturbing the feedback coefficient matrix F\tilde{ } based on the above formula (24), but the embodiment is not limited thereto. For example, the policy improvement device 100 may use another method of applying perturbation.

(Example of Estimation Processing Procedure)

Next, with reference to FIG. 12, description is given of an example of estimation processing procedure for calculating the estimated function of the partial derivative of the state value function with respect to the coefficient Fᵢⱼ, which is a specific example of step S1105.

FIG. 12 is a flowchart illustrating an example of estimation processing procedures. In FIG. 12, first, the policy improvement device 100 contracts the states xₜ, Xₜ₋₁, . . . , x_{t-N′-1}, and calculates TD errors δₜ₋₁, . . . , δ_{t-N′-2} based on the following formula (25) (step S1201).

δₜ₋₁:=cₜ₋₁−{\hat{v}(\tilde{x}ₜ₋₁:\tilde{F})−γ\hat{v}(\tilde{x}ₜ:\tilde{F})}

δₜ₋₂:=cₜ₋₂−{\hat{v}(\tilde{x}ₜ₋₂:\tilde{F})−γ\hat{v}(\tilde{x}ₜ₋₁:\tilde{F})}

δ_{t-N′-2}:=c_{t-N′-2}−{\hat{v}(\tilde{x}_{t-N′-2}:\tilde{F})−γ\hat{v}(\tilde{x}_{t-N′-1}:\tilde{F})} (25)

Next, the policy improvement device 100 acquires the result of dividing the TD errors δₜ₋₁, δ_{t-N′-2} by the perturbation E, based on the following formula (26) (step S1202).

$$\frac{1}{ɛ} {δ}_{t - 1} , \frac{1}{ɛ} {δ}_{t - 2} , … \frac{1}{ɛ} {δ}_{t - {N}^{′} - 2} \qquad ( 26 )$$

The policy improvement device 100 calculates an estimated vector θ\hat{ }F_{\tilde{ }ij}^{F\tilde{ } of the vector θ}_{F\tilde{ }ij}^{F\tilde{ } by the collective least-squares method based on the following formula (}27) (step S1203). For convenience, a symbol with a subscript F\tilde{ }ᵢⱼ and a superscript F\tilde{ } attached to θ described in the drawings, formulas, and the like, for example, is expressed as “θ_{F\tilde{ }ij}^{F\tilde{ }}” in the description. For convenience, a symbol with \hat{ } attached to the upper part of θ_{F\tilde{ }ij}^{F\tilde{ } described in the drawings, formulas, and the like, for example, is expressed as “θ\hat{ }}_{F\tilde{ }ij}^{F\tilde{ }}” in the description.

$${\hat{θ}}_{\tilde{F} ij}^{\tilde{F}} := {[ \begin{matrix}{\{ ( {\tilde{x}}_{t - 1} ⊗ {\tilde{x}}_{t - 1} ) - γ ( {\tilde{x}}_{t} ⊗ {\tilde{x}}_{t} ) \}}^{T} \\ {\{ ( {\tilde{x}}_{t - 2} ⊗ {\tilde{x}}_{t - 2} ) - γ ( {\tilde{x}}_{t - 1} ⊗ {\tilde{x}}_{t - 1} ) \}}^{T} \\ ⋮ \\ {\{ ( {\tilde{x}}_{t - {N}^{′} - 2} ⊗ {\tilde{x}}_{t - {N}^{′} - 2} ) - γ ( {\tilde{x}}_{t - {N}^{′} - 1} ⊗ {\tilde{x}}_{t - {N}^{′} - 1} ) \}}^{T}\end{matrix} ]}^{†} [ \begin{matrix}\frac{1}{ɛ} {δ}_{t - 1} \\ \frac{1}{ɛ} {δ}_{t - 2} \\ ⋮ \\ \frac{1}{ɛ} {δ}_{t - {N}^{′} - 2}\end{matrix} ] \qquad ( 27 )$$

A superscript T represents transposition. The symbol with superimposed “∘” and “x” indicates the Kronecker product. † indicates a generalized inverse matrix of Moore-Penrose.

The above formula (27) is obtained by forming an approximation equation with the vector corresponding to the above formula (26) and the product of the estimated vector θ\hat{ }_{F\tilde{ }ij}^{F\tilde{ }} of the state-independent vector θ_{F\tilde{ }ij}^{F\tilde{ }} and the state-dependent matrix defined by the following formula (28), and by modifying the approximation equation.

$$[ \begin{matrix}{\{ ( {\tilde{x}}_{t - 1} ⊗ {\tilde{x}}_{t - 1} ) - γ ( {\tilde{x}}_{t} ⊗ {\tilde{x}}_{t} ) \}}^{T} \\ {\{ ( {\tilde{x}}_{t - 2} ⊗ {\tilde{x}}_{t - 2} ) - γ ( {\tilde{x}}_{t - 1} ⊗ {\tilde{x}}_{t - 1} ) \}}^{T} \\ ⋮ \\ {\{ ( {\tilde{x}}_{t - {N}^{′} - 2} ⊗ {\tilde{x}}_{t - {N}^{′} - 2} ) - γ ( {\tilde{x}}_{t - {N}^{′} - 1} ⊗ {\tilde{x}}_{t - {N}^{′} - 1} ) \}}^{T}\end{matrix} ] \qquad ( 28 )$$

The product of the estimated vector θ\hat{ }_{F\tilde{ }ij}^{F\tilde{ } of the state-independent vector θ}_{F\tilde{ }ij}^{F\tilde{ } and the state-dependent matrix defined by the above formula (}28) corresponds to the result of differentiating the state value function with respect to the (i, j) element of the feedback coefficient matrix F″.

The policy improvement device 100 uses the estimated vector θ\hat{ }_{F\tilde{ }ij}^{F\tilde{ } of the vector θ}_{F\tilde{ }ij}^{F\tilde{ } based on the following formula (}29) to generate an estimated matrix ∂P\hat{ }_{F\tilde{ }}/∂F\tilde{ }ᵢⱼ of a matrix ∂P_{F\tilde{ }}/∂F\tilde{ }ᵢⱼ (step S1204). For convenience, a symbol with \hat{ } attached to the upper part of ∂P_{F\tilde{ }}/∂F\tilde{ }ᵢⱼ described in the drawings, formulas, and the like, for example, is expressed as “∂P\hat{ }_{F\tilde{ }}/∂F\tilde{ }ᵢⱼ” in the description.

$$\frac{\partial {\tilde{F}}_{ij}}{} \text{:} {vec}_{{n}^{′} \times {n}^{′}}^{- 1} ( {\hat{θ}}_{{\tilde{F}}_{ij}}^{\tilde{F}} ) \qquad ( 29 )$$

vec⁻¹ is a symbol that converts a vector back into a matrix.

Next, the policy improvement device 100 calculates an estimated function ∂v\hat{ }/∂F\tilde{ }ᵢⱼ of the partial derivative ∂v/∂F\tilde{ }ᵢⱼ obtained by partially differentiating the state value function with respect to F\tilde{ }ᵢⱼ based on the following formula (30) (step S1205). The policy improvement device 100 then terminates the estimation processing.

$$\frac{\partial {\tilde{F}}_{ij}}{} ( \tilde{x} \text{:} \tilde{F} ) = {\tilde{x}}^{T} \frac{\partial {\tilde{F}}_{ij}}{} \tilde{x} \qquad ( 30 )$$

(Example of Update Processing Procedure)

Next, with reference to FIG. 13, description is given of an example of an update processing procedure, which is a specific example of step S1107, in which the policy improvement device 100 updates the feedback coefficient matrix F\tilde{ }.

FIG. 13 is a flowchart illustrating an example of update processing procedures. In FIG. 13, the policy improvement device 100 uses the estimated function ∂v\hat{ }/∂F\tilde{ }ᵢⱼ of the partial derivative ∂v/∂F\tilde{ }ᵢⱼ to generate an estimated gradient function matrix ∇\hat{ }_{F\tilde{ }}v(x\tilde{ }:F\tilde{ }) by estimating the gradient function matrix ∇F\tilde{ }v(x\tilde{ }:F\tilde{ }) of the feedback coefficient matrix F\tilde{ } based on the following formula (31) (step S1301).

$$\begin{matrix} ( \tilde{x} \text{:} \tilde{F} ) = ( \begin{matrix}{\tilde{x}}^{T} \frac{\partial {\tilde{F}}_{11}}{} \tilde{x} & … & {\tilde{x}}^{T} \frac{\partial {\tilde{F}}_{1 {n}^{′}}}{} \tilde{x} \\ ⋮ & ⋱ & ⋮ \\ {\tilde{x}}^{T} \frac{\partial {\tilde{F}}_{m 1}}{} \tilde{x} & … & {\tilde{x}}^{T} \frac{\partial {\tilde{F}}_{m {n}^{′}}}{} \tilde{x}\end{matrix} ) \\ = ( \begin{matrix}{( \tilde{x} ⊗ \tilde{x} )}^{T} {\hat{θ}}_{{\tilde{F}}_{11}}^{\tilde{F}} & … & {( \tilde{x} ⊗ \tilde{x} )}^{T} {\tilde{θ}}_{{\tilde{F}}_{1 {n}^{′}}}^{\tilde{F}} \\ ⋮ & ⋱ & ⋮ \\ {( \tilde{x} ⊗ \tilde{x} )}^{T} {\hat{θ}}_{{\tilde{F}}_{m 1}}^{\tilde{F}} & … & {( \tilde{x} ⊗ \tilde{x} )}^{T} {\tilde{θ}}_{{\tilde{F}}_{m {n}^{′}}}^{\tilde{F}}\end{matrix} ) \\ = ( \begin{matrix}{( \tilde{x} ⊗ \tilde{x} )}^{T} & … & 0 \\ ⋮ & ⋱ & ⋮ \\ 0 & … & {( \tilde{x} ⊗ \tilde{x} )}^{T}\end{matrix} ) ( \begin{matrix}{\hat{θ}}_{{\tilde{F}}_{11}}^{\tilde{F}} & … & {\tilde{θ}}_{{\tilde{F}}_{1 {n}^{′}}}^{\tilde{F}} \\ ⋮ & ⋱ & ⋮ \\ {\hat{θ}}_{{\tilde{F}}_{m 1}}^{\tilde{F}} & … & {\tilde{θ}}_{{\tilde{F}}_{m {n}^{′}}}^{\tilde{F}}\end{matrix} ) \\ = ( I ⊗ {( \tilde{x} ⊗ \tilde{x} )}^{T} ) ( \begin{matrix}{\hat{θ}}_{{\tilde{F}}_{11}}^{\tilde{F}} & … & {\tilde{θ}}_{{\tilde{F}}_{1 {n}^{′}}}^{\tilde{F}} \\ ⋮ & ⋱ & ⋮ \\ {\hat{θ}}_{{\tilde{F}}_{m 1}}^{\tilde{F}} & … & {\tilde{θ}}_{{\tilde{F}}_{m {n}^{′}}}^{\tilde{F}}\end{matrix} )\end{matrix} \qquad ( 31 )$$

The policy improvement device 100 updates the feedback coefficient matrix F\tilde{ } based on the above formula (13) (step S1302). The policy improvement device 100 then terminates the update processing. Accordingly, the policy improvement device 100 may update the feedback coefficient matrix F\tilde{ } so that the state value function is improved and the cumulative cost or the cumulative reward is efficiently optimized. The policy improvement device 100 may generate an estimated gradient function matrix into which an arbitrary x may be substituted.

A description has been provided for the case where the policy improvement device 100 realizes reinforcement learning based on the immediate cost, but the embodiment is not limited thereto. For example, the policy improvement device 100 may realize reinforcement learning based on the immediate reward. In this case, the policy improvement device 100 uses the above formula (14) instead of the above formula (13).

A start trigger for starting the reinforcement learning process illustrated in FIGS. 9 and 10 is, for example, that there is a predetermined operation input by the user. The start trigger may be reception of a predetermined signal from another computer, for example. The start trigger may be, for example, that a predetermined signal is generated in the policy improvement device 100.

As described above, the policy improvement device 100 makes it possible to calculate the estimated parameter by estimating the parameter of the state value function with respect to the state of the control target 110. The policy improvement device 100 makes it possible to contract the state space of the control target 110 using the calculated estimated parameter. The policy improvement device 100 makes it possible to generate a TD error with respect to the estimated state value function that estimates the state value function in the contracted state space of the control target 110 by perturbing each parameter that defines the policy. The policy improvement device 100 makes it possible to generate an estimated gradient that estimates the gradient of the state value function for the parameter that defines the policy, based on the generated TD error and the perturbation. The policy improvement device 100 makes it possible to update the parameter that defines the policy, by using the generated estimated gradient. Thus, the policy improvement device 100 is capable of reducing the number of elements of the parameter that defines the policy even when the problem representing the control target 110 is not linear or the problem representing the control target 110 is unknown. Therefore, the policy improvement device 100 is capable of improving the learning efficiency in the reinforcement learning and reducing the processing time taken for the reinforcement learning.

The policy improvement device 100 makes it possible to generate an estimated coefficient matrix obtained by estimating the coefficient matrix of the state value function for the state of the control target 110. The policy improvement device 100 makes it possible to contract the state space of the control target 110 using the generated estimated coefficient matrix. The policy improvement device 100 makes it possible to generate a TD error with respect to an estimated state value function that estimates the state value function in the contracted state space of the control target 110 by perturbing each of the elements of the feedback coefficient matrix that defines the policy. The policy improvement device 100 makes it possible to generate an estimated gradient function matrix that estimates the gradient function matrix of the state value function with respect to the feedback coefficient matrix, based on the generated TD error and the perturbation. The policy improvement device 100 makes it possible to update the feedback coefficient matrix by using the generated estimated gradient function matrix. As a result, the policy improvement device 100 may be applied when the problem representing the control target 110 is linear.

The policy improvement device 100 makes it possible to use as the input at least any of a set temperature of the air conditioning apparatus and a set air volume of the air conditioning apparatus. The policy improvement device 100 makes it possible to use as the state at least any of the temperature inside a room with the air conditioning apparatus, the temperature outside the room with the air conditioning apparatus, and the climate. The policy improvement device 100 makes it possible to use as the cost the power consumption of the air conditioning apparatus. As a result, the policy improvement device 100 may be applied when the control target 110 is an air conditioning apparatus.

The policy improvement device 100 makes it possible to use as the input the generator torque of the power generation apparatus. The policy improvement device 100 makes it possible to use as the state at least any of the power generation amount of the power generation apparatus, the rotation amount of the turbine of the power generation apparatus, the rotation speed of the turbine of the power generation apparatus, the wind direction with respect to the power generation apparatus, and the wind speed with respect to the power generation apparatus. The policy improvement device 100 makes it possible to use as the reward the power generation amount of the power generation apparatus. As a result, the policy improvement device 100 may be applied when the control target 110 is a power generation apparatus.

The policy improvement device 100 makes it possible to use as the input the motor torque of the industrial robot. The policy improvement device 100 makes it possible to use as the state at least any of an image taken by the industrial robot, a joint position of the industrial robot, a joint angle of the industrial robot, and a joint angular velocity of the industrial robot. The policy improvement device 100 makes it possible to use as the reward the production amount of the industrial robot. As a result, the policy improvement device 100 may be applied when the control target 110 is an industrial robot.

The policy improvement device 100 makes it possible to output the updated policy parameter. Thus, the policy improvement device 100 makes it possible for another computer to refer to the updated policy parameter and to control the control target 110.

The policy improvement method described in this embodiment may be realized by executing a program prepared in advance on a computer such as a personal computer or a workstation. The policy improvement program described according to the embodiment is recorded on a computer-readable recording medium, such as a hard disk, a flexible disk, a compact disc read-only memory (CD-ROM), a magneto-optical (MO) disc, or a digital versatile disc (DVD), and is executed as a result of being read from the recording medium by a computer. The policy improvement program described according to the embodiment may be distributed through a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A policy improvement method for reinforcement learning using a state value function, the method comprising:
calculating, when an immediate cost or immediate reward of a control target in the reinforcement learning is defined by a state and an input, an estimated parameter that estimates a parameter of the state value function for the state of the control target;
contracting a state space of the control target using the calculated estimated parameter;
generating a TD error for the estimated state value function that estimates the state value function in the contracted state space of the control target by perturbing each parameter that defines the policy;
generating an estimated gradient that estimates the gradient of the state value function with respect to the parameter that defines the policy, based on the generated TD error and the perturbation; and
updating the parameter that defines the policy using the generated estimated gradient.

2. The policy improvement method according to claim 1, the method further comprising:
generating an estimated coefficient matrix that estimates a coefficient matrix of the state value function for the state of the control target, when a state change of the control target is defined by a linear difference equation, and the immediate cost or immediate reward of the control target is defined by the quadratic form of the state and the input;
contracting a state space of the control target using the generated estimated coefficient matrix;
generating a TD error for the estimated state value function that estimates the state value function in the contracted state space of the control target by perturbing each element of a feedback coefficient matrix that defines the policy;
generating an estimated gradient function matrix that estimates a gradient function matrix of the state value function with respect to the feedback coefficient matrix, based on the generated TD error and the perturbation; and
updating the feedback coefficient matrix using the generated estimated gradient function matrix.

3. The policy improvement method according to claim 1, wherein
the control target is an air conditioning apparatus, and
the reinforcement learning is configured to
define an input as at least any of a set temperature of the air conditioning apparatus and a set air volume of the air conditioning apparatus,
define a state as at least any of a temperature inside a room with the air conditioning apparatus, a temperature outside the room with the air conditioning apparatus, and a climate, and
define a cost as power consumption of the air conditioning apparatus.

4. The policy improvement method according to claim 1, wherein
the control target is a power generation apparatus, and
the reinforcement learning is configured to
define an input as a generator torque of the power generation apparatus,
define a state as at least any of a power generation amount of the power generation apparatus, a rotation amount of a turbine of the power generation apparatus, a rotation speed of the turbine of the power generation apparatus, a wind direction with respect to the power generation apparatus, and a wind speed with respect to the power generation apparatus, and
define a reward as the power generation amount of the power generation apparatus.

5. The policy improvement method according to claim 1, wherein
the control target is an industrial robot, and
the reinforcement learning is configured to
define an input as a motor torque of the industrial robot,
define a state as at least any of an image taken by the industrial robot, a joint position of the industrial robot, a joint angle of the industrial robot, and a joint angular velocity of the industrial robot, and
define a reward as a production amount of the industrial robot.

6. A non-transitory computer-readable storage medium for storing a policy improvement program for reinforcement learning using a state value function, the policy improvement program being configured to cause a processor to perform processing, the processing comprising:
calculating, when an immediate cost or immediate reward of a control target in the reinforcement learning is defined by a state and an input, an estimated parameter that estimates a parameter of the state value function for the state of the control target;
contracting a state space of the control target using the calculated estimated parameter;
generating a TD error for the estimated state value function that estimates the state value function in the contracted state space of the control target by perturbing each parameter that defines the policy;
generating an estimated gradient that estimates the gradient of the state value function with respect to the parameter that defines the policy, based on the generated TD error and the perturbation; and
updating the parameter that defines the policy using the generated estimated gradient.

7. The non-transitory computer-readable storage medium according to claim 6, the processing further comprising:
generating an estimated coefficient matrix that estimates a coefficient matrix of the state value function for the state of the control target, when a state change of the control target is defined by a linear difference equation, and the immediate cost or immediate reward of the control target is defined by the quadratic form of the state and the input;
contracting a state space of the control target using the generated estimated coefficient matrix;
generating a TD error for the estimated state value function that estimates the state value function in the contracted state space of the control target by perturbing each element of a feedback coefficient matrix that defines the policy;
generating an estimated gradient function matrix that estimates a gradient function matrix of the state value function with respect to the feedback coefficient matrix, based on the generated TD error and the perturbation; and
updating the feedback coefficient matrix using the generated estimated gradient function matrix.

8. The non-transitory computer-readable storage medium according to claim 6, wherein
the control target is an air conditioning apparatus, and
the reinforcement learning is configured to
define an input as at least any of a set temperature of the air conditioning apparatus and a set air volume of the air conditioning apparatus,
define a state as at least any of a temperature inside a room with the air conditioning apparatus, a temperature outside the room with the air conditioning apparatus, and a climate, and
define a cost as power consumption of the air conditioning apparatus.

9. The non-transitory computer-readable storage medium according to claim 6, wherein
the control target is a power generation apparatus, and
the reinforcement learning is configured to
define an input as a generator torque of the power generation apparatus,
define a state as at least any of a power generation amount of the power generation apparatus, a rotation amount of a turbine of the power generation apparatus, a rotation speed of the turbine of the power generation apparatus, a wind direction with respect to the power generation apparatus, and a wind speed with respect to the power generation apparatus, and
define a reward as the power generation amount of the power generation apparatus.

10. The non-transitory computer-readable storage medium according to claim 6, wherein
the control target is an industrial robot, and
the reinforcement learning is configured to
define an input as a motor torque of the industrial robot,
define a state as at least any of an image taken by the industrial robot, a joint position of the industrial robot, a joint angle of the industrial robot, and a joint angular velocity of the industrial robot, and
define a reward as a production amount of the industrial robot.

11. A policy improvement device for reinforcement learning using a state value function, comprising:
a memory; and
a processor coupled to the memory, the processor being configured to:
calculating, when an immediate cost or immediate reward of a control target in the reinforcement learning is defined by a state and an input, an estimated parameter that estimates a parameter of the state value function for the state of the control target;
contracting a state space of the control target using the calculated estimated parameter;
generating a TD error for the estimated state value function that estimates the state value function in the contracted state space of the control target by perturbing each parameter that defines the policy;
generating an estimated gradient that estimates the gradient of the state value function with respect to the parameter that defines the policy, based on the generated TD error and the perturbation; and
updating the parameter that defines the policy using the generated estimated gradient.

12. The policy improvement device according to claim 11, the policy improvement device further comprising:
generating an estimated coefficient matrix that estimates a coefficient matrix of the state value function for the state of the control target, when a state change of the control target is defined by a linear difference equation, and the immediate cost or immediate reward of the control target is defined by the quadratic form of the state and the input;
contracting a state space of the control target using the generated estimated coefficient matrix;
generating a TD error for the estimated state value function that estimates the state value function in the contracted state space of the control target by perturbing each element of a feedback coefficient matrix that defines the policy;
generating an estimated gradient function matrix that estimates a gradient function matrix of the state value function with respect to the feedback coefficient matrix, based on the generated TD error and the perturbation; and
updating the feedback coefficient matrix using the generated estimated gradient function matrix.

13. The policy improvement device according to claim 11, wherein
the control target is an air conditioning apparatus, and
the reinforcement learning is configured to
define an input as at least any of a set temperature of the air conditioning apparatus and a set air volume of the air conditioning apparatus,
define a state as at least any of a temperature inside a room with the air conditioning apparatus, a temperature outside the room with the air conditioning apparatus, and a climate, and
define a cost as power consumption of the air conditioning apparatus.

14. The policy improvement device according to claim 11, wherein
the control target is a power generation apparatus, and
the reinforcement learning is configured to
define an input as a generator torque of the power generation apparatus,
define a state as at least any of a power generation amount of the power generation apparatus, a rotation amount of a turbine of the power generation apparatus, a rotation speed of the turbine of the power generation apparatus, a wind direction with respect to the power generation apparatus, and a wind speed with respect to the power generation apparatus, and
define a reward as the power generation amount of the power generation apparatus.

15. The policy improvement device according to claim 11, wherein
the control target is an industrial robot, and
the reinforcement learning is configured to
define an input as a motor torque of the industrial robot,
define a state as at least any of an image taken by the industrial robot, a joint position of the industrial robot, a joint angle of the industrial robot, and a joint angular velocity of the industrial robot, and
define a reward as a production amount of the industrial robot.
